(19) United States
(12) Patent Application Publication
(10) Pub. No.: US 2026/0279392 A1
(43) Pub. Date: Sep. 17, 2026

(54) HEAD ASSEMBLY AND DISK DRIVE

(71) Applicants: Kabushiki Kaisha Toshiba, Kawasaki-shi (JP); Toshiba Electronic Devices & Storage Corporation, Kawasaki-shi (JP)

(72) Inventors: Ryusei YOSHIDA, Yokohama Kanagawa (JP); Sinji TUKADA, Kawasaki Kanagawa (JP); Yuki SATO, Yokohama Kanagawa (JP)

(21) Appl. No.: 19/310,131

(22) Filed: Aug. 26, 2025

(30) Foreign Application Priority Data
Mar. 13, 2025 (JP) 2025-040263

(51) Int. Cl. G11B 5/48

(52) U.S. Cl. CPC G11B 5/4833; G11B 5/4846

(57) ABSTRACT

A head assembly is provided in a disk drive. The head assembly includes a head, a main body to which the head is attached, a wiring member that is electrically connected to the head, and a board that is attached to the main body. The board includes a first terminal portion. The wiring member includes a second terminal portion that is electrically joined to the first terminal portion. The main body includes an attachment surface to which the board is attached. At least a part of the first terminal portion and the second terminal portion overlap each other when seen in a first direction perpendicular to the attachment surface. A recessed portion that is recessed in a direction away from the board is formed in the attachment surface. The recessed portion overlaps at least a part of the first terminal portion when seen in the first direction.

### CROSS-REFERENCE TO RELATED APPLICATION

This application is based upon and claims the benefit of priority from Japanese Patent Application No. 2025-040263, filed on March 13, 2025; the entire contents of which are incorporated herein by reference.

### FIELD

Embodiments described herein relate generally to a head assembly and a disk drive.

### BACKGROUND

A head assembly that is provided in a disk drive is known. In this head assembly, when a board attached to a main body of the head assembly and a wiring member electrically connected to a head are electrically joined to each other, heat may be applied to the board. In this case, there is concern about damage of the board due to the heat. Specifically, for example, when the wiring member and the board are joined to each other using a joining material such as solder, heat is applied to the joining material and thus the joining material is melted. At this time, there is concern about damage of the board due to the heat applied to melt the joining material.

### BRIEF DESCRIPTION OF THE DRAWINGS

FIG. 1 is a perspective view illustrating a disk drive according to a first embodiment.

FIG. 2 is a block diagram illustrating a configuration of the disk drive according to the first embodiment.

FIG. 3 is a perspective view illustrating a head assembly and a part of a disk according to the first embodiment.

FIG. 4 is a diagram illustrating a part of the head assembly according to the first embodiment.

FIG. 5 is a perspective view illustrating a part of a main body of the head assembly according to the first embodiment.

FIG. 6 is a sectional view illustrating a part of the head assembly according to the first embodiment.

FIG. 7 is a sectional view illustrating a part of a procedure of assembling the head assembly according to the first embodiment.

FIG. 8 is a diagram illustrating a part of a disk drive according to a second embodiment.

FIG. 9 is a perspective view illustrating a part of a main body of a head assembly according to the second embodiment.

FIG. 10 is a diagram illustrating a part of a disk drive according to a third embodiment.

FIG. 11 is a perspective view illustrating a part of a main body of a head assembly according to the third embodiment.

FIG. 12 is a diagram illustrating a part of a disk drive according to a fourth embodiment.

FIG. 13 is a perspective view illustrating a part of a main body of a head assembly according to the fourth embodiment.

FIG. 14 is a sectional view illustrating a part of the head assembly according to the fourth embodiment.

### DETAILED DESCRIPTION

A head assembly according to an embodiment is a head assembly that is provided in a disk drive. The head assembly according to the embodiment includes a head, a main body to which the head is attached, a wiring member that is electrically connected to the head, and a board that is attached to the main body. The board includes a first terminal portion. The wiring member includes a second terminal portion that is electrically joined to the first terminal portion. The main body includes an attachment surface to which the board is attached. At least a part of the first terminal portion and at least a part of the second terminal portion overlap each other when seen in a first direction perpendicular to the attachment surface. A recessed portion that is recessed in a direction away from the board is formed in the attachment surface. The recessed portion overlaps at least a part of the first terminal portion when seen in the first direction.

Hereinafter, a head assembly and a disk drive according to an embodiment will be described with reference to the accompanying drawings. In the drawings, an X axis, a Y axis, and a Z axis are appropriately illustrated. In the following direction, an X-axis direction in which the X axis extends is referred to as an “attachment direction X,” a Y-axis direction in which the Y axis extends is referred to as an “extension direction Y,” and a Z-axis direction in which the Z axis extends is referred to as a “vertical direction Z.” The attachment direction X, the extension direction Y, and the vertical direction Z are perpendicular to each other. In the following embodiments, the attachment direction X corresponds to a “first direction” perpendicular to the attachment surface, and the vertical direction Z corresponds to a “second direction” perpendicular to the first direction.

In the following description, a side (a +Z side) indicated by an arrow of the Z axis in the vertical direction Z is referred to as a “top side,” and a side (a –Z side) opposite to the side indicated by the arrow of the Z axis in the vertical direction Z is referred to as a “bottom side.” A side (a +X side) indicated by an arrow of the X axis in the attachment direction X is referred to as a “first side,” and a side (a –X side) opposite to the side indicated by the arrow of the X axis in the attachment direction X is referred to as a “second side.” A side (a +Y side) indicated by an arrow of the Y axis in the extension direction Y is referred to as an “extension-direction one side,” and a side (a –Y side) opposite to the side indicated by the arrow of the Y axis in the extension direction Y is referred to as an “extension-direction other side.” The names of the directions are only for explaining arrangement relationships between the constituents or the like, and actual arrangement relationships or the like may be arrangement relationships or the like other than the arrangement relationships indicated by these names.

### First embodiment

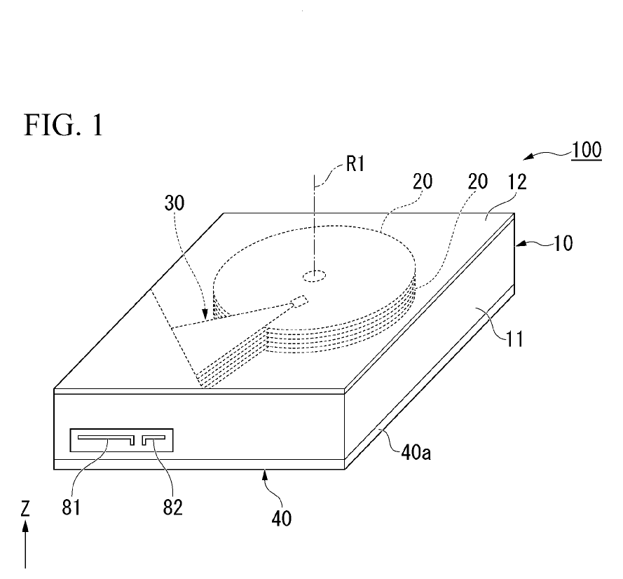

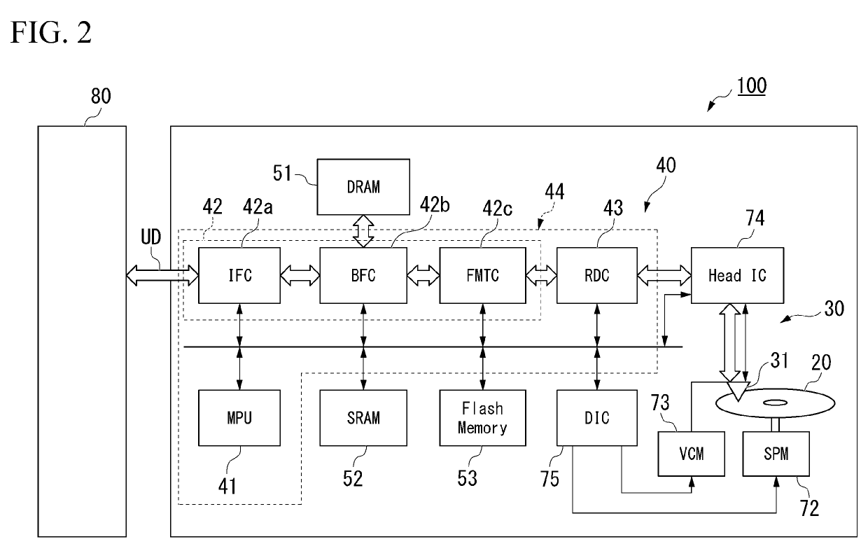

FIG. 1 is a perspective view illustrating a disk drive 100 according to a first embodiment. FIG. 2 is a block diagram illustrating a configuration of the disk drive 100 according to the first embodiment. The disk drive 100 according to the first embodiment illustrated in FIGS. 1 and 2 is a magnetic disk drive into which a hard disk drive is incorporated. The disk drive 100 can store information as digital data. The disk drive 100 is driven on the basis of an instruction from a host device 80. The host device 80 is, for example, a personal computer. The host device 80 is not particularly limited as long as it is a device that gives an instruction to the disk drive 100. The host device 80 can write information to the disk drive 100 and read data stored in the disk drive 100.

As illustrated in FIG. 1, the disk drive 100 includes a case 10, a disk 20, a head assembly 30, a control device 40, a power supply terminal 81, and a connection terminal 82. As illustrated in FIG. 2, the disk drive 100 includes a spindle motor 72 and a voice coil motor 73.

As illustrated in FIG. 1, the case 10 accommodates the disk 20 and the head assembly 30 therein. In the first embodiment, the case 10 has a rectangular parallelepiped box shape. The case 10 includes a case body 11 and a lid member 12. The case body 11 is a rectangular parallelepiped box shape which is open upward (to the +Z side). The disk 20 and the head assembly 30 are accommodated in the case body 11. The lid member 12 is fixed to an upper end of the case body 11. The lid member 12 closes an upper opening of the case body 11.

In the first embodiment, the disk 20 is a magnetic disk. The disk 20 has a circulate plate shape. The disk 20 is rotated around a rotation axis R1 extending in the vertical direction Z by the spindle motor 72. The disk 20 includes a recording surface on which digital data is recorded. In the first embodiment, a plurality of disks 20 are arranged at intervals in the vertical direction Z. The number of disks 20 is not particularly limited as long as it is equal to or greater than one.

The control device 40 is a device that controls the disk drive 100. The control device 40 is attached to an outer surface of the case 10. In the first embodiment, the control device 40 is attached to a surface of the case 10 on the lower side (the –Z side). For example, at least a part of the control device 40 is exposed to the outside of the case 10. The control device 40 includes a circuit board 40a. The circuit board 40a is a printed circuit board (PCB).

As illustrated in FIG. 2, the control device 40 includes a controller 44, a driver IC 75, a first volatile memory 51, a second volatile memory 52, and a nonvolatile memory 53. The driver IC 75, the first volatile memory 51, the second volatile memory 52, and the nonvolatile memory 53 are mounted on, for example, the circuit board 40a.

The controller 44 is a system controller that controls the disk drive 100. The controller 44 is, for example, a large scale integration (LSI) circuit called system-on-a-chip (SoC) in which a plurality of elements such as microprocessors are integrated on a single chip. The controller 44 is electrically connected to the driver IC 75, the first volatile memory 51, the second volatile memory 52, and the nonvolatile memory 53. The controller 44 includes a microprocessor 41, a hard disk controller 42, and a read/write channel 43.

The hard disk controller 42 controls transmission of data between the host device 80 and the read/write channel 43 on the basis of an instruction from the microprocessor 41. The hard disk controller 42 is electrically connected to the microprocessor 41, the read/write channel 43, a head amplifier IC 74 which will be described later, the driver IC 75, the first volatile memory 51, the second volatile memory 52, and the nonvolatile memory 53. The hard disk controller 42 includes an interface control unit 42a, a buffer control unit 42b, and a format control unit 42c. The interface control unit 42a controls an interface with the host device 80. The interface control unit 42a reads an instruction input from the host device 80 and performs reception and transmission of data and the like. The buffer control unit 42b temporarily stores data input from the host device 80 via the interface control unit 42a and data read from the disk 20 in the first volatile memory 51. The format control unit 42c converts formats of data input from the buffer control unit 42b and data input from the read/write channel 43.

The read/write channel 43 performs signal processing of data transmitted from the disk 20 to the host device 80 and signal processing of data transmitted from the host device 80 to the disk 20 on the basis of an instruction from the microprocessor 41. The read/write channel 43 has, for example, a function of measuring signal quality of data.

The first volatile memory 51 and the second volatile memory 52 are semiconductor memories in which data stored therein disappears when supply of electric power is cut off. In the first embodiment, data is temporarily stored in the first volatile memory 51 by the buffer control unit 42b. In the first embodiment, the first volatile memory 51 is a dynamic random access memory (DRAM). In the first embodiment, the first volatile memory 51 is used as a cache of read data read from the disk 20 and write data written to the disk 20. Data or the like required for processing in the constituents of the disk drive 100 is stored in the second volatile memory 52. In the first embodiment, the second volatile memory 52 is a static random access memory (SRAM). The first volatile memory 51 and the second volatile memory 52 may be unified as a single volatile memory. The first volatile memory 51 may be an SRAM, a synchronous dynamic random access memory (SDRAM), a ferroelectric random access memory (FeRAM), a magnetoresistive random access memory (MRAM), or the like. The second volatile memory 52 may be a DRAM, an SDRAM, an FeRAM, an MRAM, or the like.

The nonvolatile memory 53 is a semiconductor memory in which data stored therein is continuously stored even when supply of electric power is cut off. In the first embodiment, the nonvolatile memory 53 is a flash memory. The nonvolatile memory 53 is, for example, an NOR-type or NAND-type flash memory. At least a part of a program for driving the disk drive 100, data required before reading or writing of data with respect to the disk 20 is performed, and the like are stored in the nonvolatile memory 53.

Outlined arrows in FIG. 2 indicate a flow of user data UD. User data UD input from the host device 80 to the disk drive 100 is input to the buffer control unit 42b via the interface control unit 42a and is temporarily stored in the first volatile memory 51 by the buffer control unit 42b. The user data UD stored in the first volatile memory 51 is read by the buffer control unit 42b and is converted into a format which can be stored in the disk 20 by the format control unit 42c. The user data UD which is a conversion result is transmitted to the head amplifier IC 74 via the read/write channel 43 and is written from a head 31 which will be described later to the disk 20. When the user data UD written to the disk 20 is read by the host device 80, for example, the user data UD is read in the reversed order of the order in which the user data UD is written to the disk 20.

The microprocessor 41 is a control unit that controls the constituents of the disk drive 100 and is a main controller. The microprocessor 41 controls the voice coil motor 73 via the driver IC 75 and performs servo control for positioning a head 31 which will be described later. The microprocessor 41 controls the spindle motor 72 via the driver IC 75 such that the disk 20 is rotated. The microprocessor 41 controls an operation (a writing operation) of writing data to the disk 20. The microprocessor 41 selects a storage destination of data to be written to the disk 20. The microprocessor 41 controls an operation (a reading operation) of reading data stored in the disk 20. The microprocessor 41 controls processing of data to be read from the disk 20. The microprocessor 41 is electrically connected to the constituents of the disk drive 100.

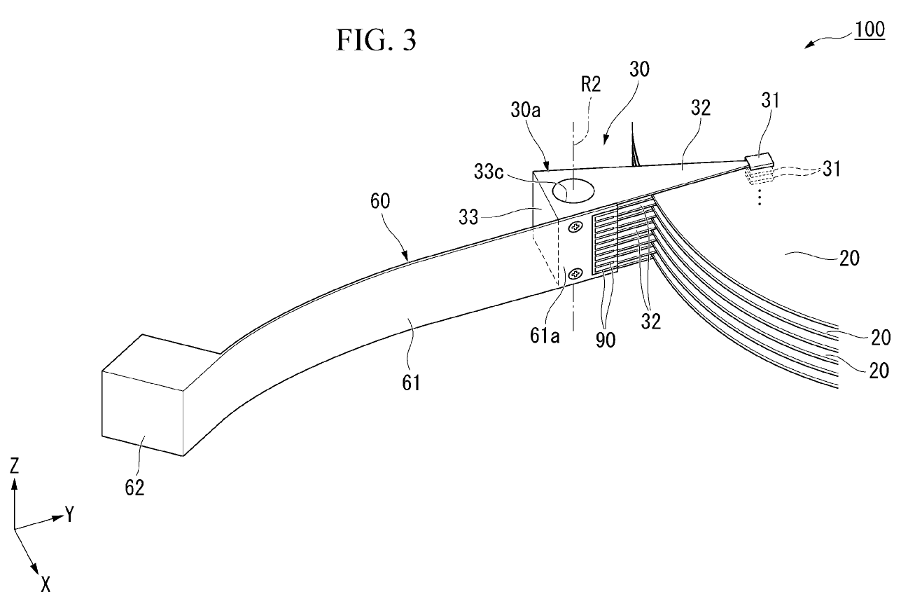

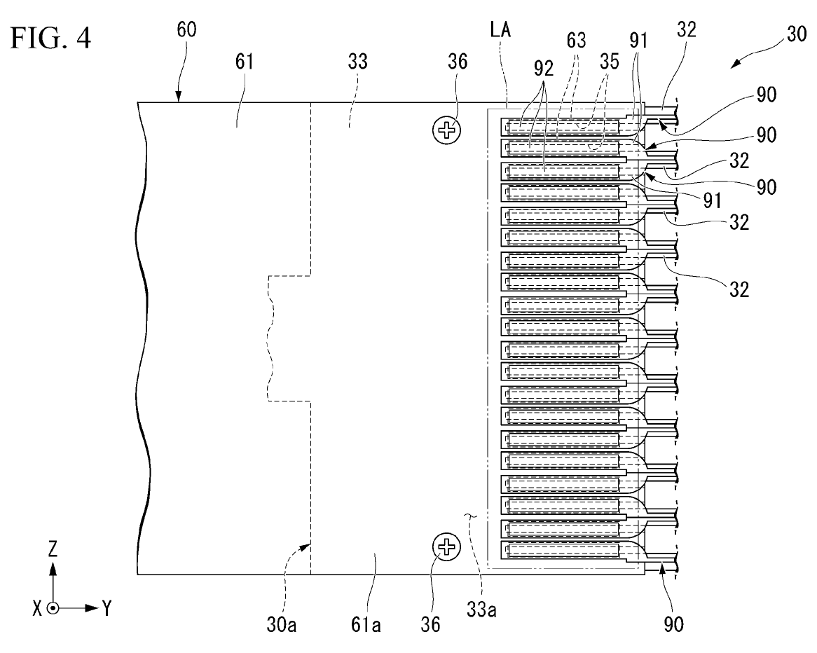

FIG. 3 is a perspective view illustrating a part of the head assembly 30 and the disk 20 according to the first embodiment. FIG. 4 is a diagram illustrating a part of the head assembly 30. The head assembly 30 illustrated in FIGS. 3 and 4 is electrically connected to the control device 40. The head assembly 30 is controlled by the control device 40 and performs writing of data to the disk 20 and reading of data stored in the disk 20. The head assembly 30 is a head stack assembly that is provided in the disk drive 100. The head assembly 30 is rotated around a rotation axis R2 by the voice coil motor 73. The rotation axis R2 extends in the vertical direction Z. That is, the vertical direction Z in the first embodiment corresponds to an axial direction in which the rotation axis R2 extends.

As illustrated in FIG. 3, the head assembly 30 includes a main body 30a, a plurality of heads 31, a board 60, and a plurality of wiring members 90. As illustrated in FIG. 2, the head assembly 30 includes the head amplifier IC 74. Although not illustrated, the head amplifier IC 74 includes a read amplifier and a write driver. The read amplifier amplifies a signal of data read from a disk 20 by the head 31 and outputs the amplified signal to the read/write channel 43 in the controller 44. The write driver outputs a write current corresponding to data output from the read/write channel 43 to the head 31. The head 31 writes data to the disk 20 on the basis of the write current output from the write driver. The head amplifier IC 74 is mounted on the board 60.

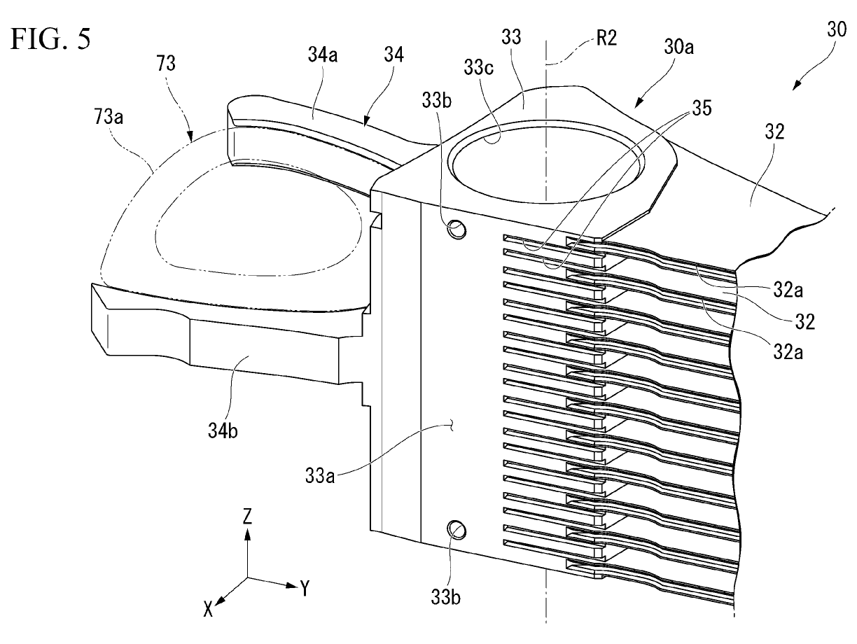

FIG. 5 is a perspective view illustrating a part of the main body 30a of the head assembly 30. As illustrated in FIG. 5, the main body 30a includes a base 33, a plurality of arms 32, and a holder 34. The base 33 has a substantially quadrangular prism shape extending in the vertical direction Z. A through-hole 33c penetrating the base 33 in the vertical direction Z is formed in the base 33. The through-hole 33c is a circular shape centered on the rotation axis R2 when seen in the vertical direction Z. The base 33 includes an attachment surface 33a to which the board 60 is attached. The attachment surface 33a is perpendicular to the attachment direction X. The attachment surface 33a faces a first side (the +X side) in the attachment direction X. The attachment surface 33a constitutes a part of a surface on the first side (the +X side) of the base 33.

A plurality of screw holes 33b which are recessed to a second side (the –X side) in the attachment direction X are formed in the attachment surface 33a. In the first embodiment, the number of screw holes 33b is two. The two screw holes 33b are arranged at an interval in the vertical direction Z. The two screw holes 33b are formed in a part on the extension-direction other side (the –Y side) of the attachment surface 33a.

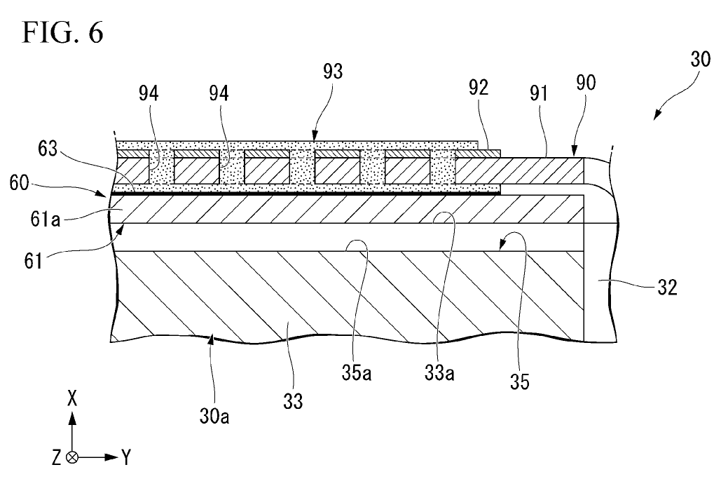

A plurality of recessed portions 35 which are recessed in a direction in which they are separated from the board 60 are formed in the attachment surface 33a. The plurality of recessed portions 35 are recessed from the attachment surface 33a to the second side (the –X side). In the first embodiment, the plurality of recessed portions 35 are formed in a part on the extension-direction one side (the +Y side) of the attachment surface 33a. The plurality of recessed portions 35 are located on the extension-direction one side with respect to the plurality of screw holes 33b. The plurality of recessed portions 35 extend in the extension direction Y. The plurality of recessed portions 35 are arranged in the vertical direction Z. In the first embodiment, the plurality of recessed portions 35 are arranged at equal intervals in the vertical direction Z. Ends on the extension-direction one side of the plurality of recessed portions 35 are formed in an edge on the extension-direction one side of the attachment surface 33a. The inside of the plurality of recessed portions 35 is open to the extension-direction one side. FIG. 6 is a sectional view illustrating a part of the head assembly 30. As illustrated in FIG. 6, the plurality of recessed portions 35 are recessed portions including a bottom surface 35a on the second side. The bottom surface 35a faces the first side (the +X side). The bottom surface 35a faces the board 60 with a gap in the attachment direction X. The bottom surface 35a is separated from a surface on the second side of the board 60 to the second side. The bottom surface 35a is located on the second side with respect to the attachment surface 33a.

As illustrated in FIG. 3, the plurality of arms 32 extend from the base 33 to the extension-direction one side (the +Y side). The plurality of arms 32 are arranged at intervals in the vertical direction Z. In the first embodiment, the plurality of arms 32 are arranged at equal intervals in the vertical direction Z. The plurality of arms 32 have a plate shape of which a plate surface faces the vertical direction Z. As illustrated in FIG. 5, a groove 32a extending in the extension direction Y is formed in a surface on the first side (the +X side) of each of the plurality of arms 32. An end on the extension-direction other side (the –Y side) of each groove 32a is formed in the base 33. An end on the extension-direction other side of the groove 32a is located on the extension-direction one side (the +Y side) with respect to the ends on the extension-direction other side of the recessed portions 35. In the first embodiment, a part on the extension-direction one side (the +Y side) of two recessed portions 35 is located between parts, which are formed in the base 33, of the grooves 32a adjacent to each other in the vertical direction.

As illustrated in FIG. 3, heads 31 are attached to tips of the plurality of arms 32. Accordingly, the plurality of heads 31 are attached to the main body 30a. At the tips of the arms 32 other than the arm 32 located on the uppermost side and the arm 32 located on the lowermost side, the corresponding heads 31 are attached to the surfaces on both sides in the vertical direction Z. At the tip of the arm 32 located on the uppermost side, a head 31 is attached to the bottom surface. At the tip of the arm 32 located on the lowermost side, a head 31 is attached to the top surface.

Each head 31 is a magnetic head that can read data stored in the corresponding disk 20 and write data to the corresponding disk 20. The head 31 can perform reading of data from the recording surface of the disk 20 and writing of data to the recording surface of the disk 20 at a position facing the recording surface of the disk 20. By causing the voice coil motor 73 to rotate the head assembly 30 around the rotation axis R2, each head 31 attached to the tip of the corresponding arm 32 moves to a position facing the recording surface of the corresponding disk 20 and a position not facing the recording surface of the disk 20.

As illustrated in FIG. 5, the holder 34 is formed on the surface on the extension-direction other side (the –Y side) of the base 33. The holder 34 includes a pair of protrusions 34a and 34b protruding from the base 33 to the extension-direction other side. The protrusions 34a and 34b are arranged at an interval in the attachment direction X. A coil 73a of the voice coil motor 73 is held between the pair of protrusions 34a and 34b in the attachment direction X. In the first embodiment, the head assembly 30 includes the coil 73a. The holder 34 is not illustrated in FIG. 3.

As illustrated in FIG. 3, the board 60 is attached to the main body 30a. In the first embodiment, the board 60 is a flexible board. The board 60 connects the circuit board 40a and the main body 30a. The board 60 includes a board body 61 and a connector portion 62. The connector portion 62 is connected to a connector portion (not illustrated) provided in the circuit board 40a. Accordingly, the board 60 is electrically connected to the circuit board 40a. The board body 61 extends from the connector portion 62 and is fixed to the main body 30a. The board body 61 includes an attached portion 61a that is attached to the attachment surface 33a. The attached portion 61a has a plate shape of which a plate surface faces the attachment direction X. The attached portion 61a is attached to the attachment surface 33a with two screw members 36. The two screw members 36 penetrate the attached portion 61a in the attachment direction X and are screwed to the two screw holes 33b. By fixing the attached portion 61a to the attachment surface 33a, the board 60 is attached to the main body 30a. As illustrated in FIG. 6, a surface on the second side (the –X side) of the attached portion 61a is in contact with the attachment surface 33a. Although not illustrated, the head amplifier IC 74 is attached to the surface on the first side (the +X side) of the attached portion 61a.

As illustrated in FIG. 4, the board 60 includes a plurality of first terminal portions 63. In the first embodiment, the plurality of first terminal portions 63 are formed on the surface on the first side (the +X side) of the attached portion 61a. More specifically, the plurality of first terminal portions 63 are formed in a part on the extension-direction one side (the +Y side) of a surface on the first side of the attached portion 61a. The plurality of first terminal portions 63 are arranged at intervals in the vertical direction Z. More specifically, the plurality of first terminal portions 63 are arranged at equal intervals in the vertical direction Z. In the first embodiment, the plurality of first terminal portions 63 extend in the extension direction Y. Each first terminal portion 63 is electrically connected to one end of a wiring pattern (not illustrated) formed in the board body 61. The other end of the wiring pattern (not illustrated) formed in the board body 61 is electrically connected to the connector portion 62 and is electrically connected to the circuit board 40a via the connector portion 62.

Each first terminal portion 63 is disposed on the first side (the +X side) of the corresponding recessed portion 35. Each recessed portion 35 overlaps at least a part of the corresponding first terminal portion 63 when seen in the attachment direction X. In the first embodiment, each recessed portion 35 overlaps a part of the corresponding first terminal portion 63 when seen in the attachment direction X. In the first embodiment, an end on the extension-direction one side (the +Y side) of each recessed portion 35 is located on the extension-direction one side with respect to an end of the extension-direction one side of the corresponding first terminal portion 63. In the first embodiment, an end on the extension-direction other side (the –Y side) of each recessed portion 35 is located on the extension-direction other side with respect to an end of the extension-direction other side of the corresponding first terminal portion 63.

The plurality of wiring members 90 are electrically connected to the plurality of heads 31. In the present embodiment, the plurality of wiring members 90 are flexible boards extending in the extension direction Y. Parts including ends on the extension-direction other side (the –Y side) of the plurality of wiring members 90 are disposed to overlap the first side (the +X side) of the board 60. Parts located on the extension-direction one side (the +Y side) with respect to the base 33 in the plurality of wiring members 90 extend to the corresponding heads 31 via the inside of the grooves 32a formed in the corresponding arms 32.

Each of the plurality of wiring members 90 includes a wiring body 91 and a second terminal portion 92. The wiring body 91 extends in the extension direction Y. A part of an end on the extension-direction other side (the –Y side) of the wiring body 91 is disposed to overlap the first side (the +X side) of the board 60. Although not illustrated, a wiring pattern is formed in each wiring body 91. One end of the wiring pattern formed in the wiring body 91 is electrically connected to the corresponding head 31. The other end of the wiring pattern formed in the wiring body 91 is electrically connected to the corresponding second terminal portion 92.

Each second terminal portion 92 is formed on the surface on the first side of a part disposed on the first side (the +X side) of the board 60 in the wiring body 91. In the first embodiment, the second terminal portions 92 extend in the extension direction Y. The second terminal portions 92 of the plurality of wiring members 90 are disposed on the first side of the corresponding first terminal portions 63. At least a part of each first terminal portion 63 and at least a part of the corresponding second terminal portion 92 overlap each other when seen in the attachment direction X. In the first embodiment, the first terminal portions 63 and the second terminal portions 92 overlap each other almost as a whole when seen in the attachment direction X.

Each second terminal portion 92 is disposed on the first side (the +X side) of the corresponding recessed portion 35. Each recessed portion 35 overlaps at least a part of the corresponding second terminal portion 92 when seen in the attachment direction X. In the first embodiment, each recessed portion 35 overlaps a part of the corresponding second terminal portion 92 when seen in the attachment direction X. In the first embodiment, an end on the extension-direction one side (the +Y side) of each recessed portion 35 is located on the extension-direction one side with respect to an end on the extension-direction one side of the corresponding second terminal portion 92. In the first embodiment, an end on the extension-direction other side (the -Y side) of each recessed portion 35 is located on the extension-direction other side with respect to an end on the extension-direction other side of the corresponding second terminal portion 92.

As illustrated in FIG. 6, a plurality of through-holes 94 penetrating each wiring member 90 in the attachment direction X are formed in each wiring member 90. The plurality of through-holes 94 are formed at intervals in the extension direction Y. The plurality of through-holes 94 penetrate the wiring bodies 91 and the second terminal portions 92 in the attachment direction X.

The plurality of first terminal portions 63 and the second terminal portions 92 of the plurality of wiring members 90 are electrically connected to each other by a joining material 93. The joining material 93 has conductivity. The joining material 93 is a material that can electrically connect objects by bonding the objects in a state in which the material is melted and then curing the material. In the first embodiment, the joining material 93 is solder. The joining material 93 includes a portion in contact with a surface on the first side (the +X side) of each first terminal portion 63, a portion located in the plurality of through-holes 94, and a portion in contact with the surface on the first side of each second terminal portion 92. The joining material 93 is not limited to solder. The joining material 93 may be, for example, a silver paste.

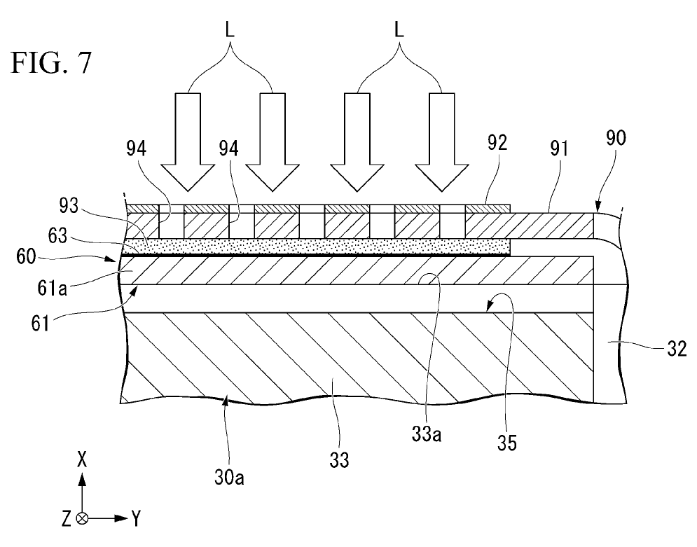

An operator or the like who assembles the head assembly 30 fixes the board 60 to the attachment surface 33a of the main body 30a to which the plurality of heads 31 and the plurality of wiring members 90 have been attached using a plurality of screw members 36. At this time, the joining material 93 is attached to the plurality of first terminal portions 63 of the board 60. The operator or the like covers the plurality of first terminal portions 63 of the board 60 with the parts of the plurality of wiring members 90 in which the second terminal portions 92 have been formed from the first side (the +X side). Accordingly, as illustrated in FIG. 7, the board 60 and the plurality of wiring members 90 overlap the first side (the +X side) of the attachment surface 33a. At this time, the joining material 93 is disposed between the board 60 and the wiring members 90 in the attachment direction X. FIG. 7 is a sectional view illustrating a part of a procedure of assembling the head assembly 30.

As illustrated in FIG. 7, the operator or the like melts the joining material 93 by applying laser light L from the first side (the +X side) of the plurality of wiring members 90. As illustrated in FIG. 4, a lighting area LA of the laser light L applied when the joining material 93 is melted in the first embodiment is an area including all the plurality of first terminal portions 63 and all the plurality of second terminal portions 92 when seen in the attachment direction X. A part of the joining material 93 melted by the laser light L intrudes to the surface on the first side (the +X side) of each second terminal portion 92 via the through-holes 94. Accordingly, the joining material 93 is attached to the second terminal portions 92. By curing the melted joining material 93, each first terminal portion 63 and the corresponding second terminal portion 92 are joined to each other, and the board 60 and the plurality of wiring members 90 are fixed to each other. The “operator or the like” in the present disclosure is not limited to an operator and may be a device that performs the operation. The operation that is performed by the operator or the like may be performed by only the operator, may be performed by only the device, or may be performed by the operator and the device.

The intensity of the laser light L decreases as it goes away in a radial direction centered on an optical axis of the laser light L from the optical axis. Accordingly, for example, as illustrated in FIG. 4, when the laser light L is applied to the lighting area LA which is long in the vertical direction Z, the intensity of the laser light L at the center in the vertical direction Z of the lighting area LA is the largest, and the intensity of the laser light L is likely to decrease as it is separated in the vertical direction Z from the center of the vertical direction Z of the lighting area LA. Accordingly, in the related art, in order to melt the joining material 93 for joining the first terminal portions 63 and the second terminal portions 92 which are disposed at both ends in the vertical direction Z, the intensity of the laser light L to be applied to the center in the vertical direction Z of the lighting area LA needs to be set to be greater than necessary intensity. In this case, the temperature of a part disposed at the center in the vertical direction Z of the lighting area LA and near the center in the board 60 increases, and there is concern about thermal damage of the board 60. Regarding this problem, it is conceivable that the whole surface on the second side (the –X side) of the board 60 be brought into contact with the attachment surface 33a and heat applied to the board 60 by the laser light L be dissipated to the main body 30a. However, in this case, when a gap is formed between the attachment surface 33a and the board 60 because a foreign substance or the like is interposed between the attachment surface 33a and the board 60, surface precision of the attachment surface 33a is poor, or the like, there is concern that heat dissipation will not be sufficiently improved and the board 60 will be damaged by the heat.

Regarding the aforementioned problem, according to the first embodiment, the head assembly 30 provided in the disk drive 100 includes a head 31, a main body 30a to which the head 31 is attached, a wiring member 90 that is electrically connected to the head 31, and a board 60 that is attached to the main body 30a. The board 60 includes a first terminal portion 63. The wiring member 90 includes a second terminal portion 92 that is electrically joined to the first terminal portion 63. The main body 30a includes an attachment surface 33a to which the board 60 is attached. At least a part of the first terminal portion 63 and at least a part of the second terminal portion 92 overlap each other when seen in an attachment direction X (a first direction) perpendicular to the attachment surface 33a. A recessed portion 35 that is recessed in a direction in which the recessed portion gets apart from the board 60 is formed in the attachment surface 33a. The recessed portion 35 overlaps at least a part of the first terminal portion 63 when seen in the attachment direction X. Accordingly, at least a part of a portion in which the first terminal portion 63 is formed in the board 60 overlaps a portion in which the recessed portion 35 is formed in the main body 30a and does not come into contact with the attachment surface 33a. As a result, when a joining material 93 in contact with the first terminal portion 63 is melted by heat, heat applied to the joining material 93 is not less dissipated to the main body 30a. Accordingly, it is possible to melt the joining material 93 while decreasing the intensity of laser light L which is applied to apply heat to the joining material 93. As a result, when the wiring member 90 and the board 60 are joined, it is possible to curb thermal damage of the board 60. By employing a method of decreasing a contact area between the board 60 and the main body 30a and storing heat in the joining material 93 when joining the wiring member 90 and the board 60, it is possible to curb non-melting of the joining material 93 while curbing thermal damage of the board 60 even when a gap is formed between the attachment surface 33a and the board 60. Accordingly, it is possible to stably join the first terminal portion 63 of the board 60 and the second terminal portion 92 of the wiring member 90.

According to the first embodiment, the head assembly 30 includes a plurality of heads 31 and a plurality of wiring members 90. The board 60 includes a plurality of first terminal portions 63 which are arranged in the vertical direction Z (a second direction) perpendicular to the attachment direction X. The plurality of first terminal portions 63 and the second terminal portions 92 of the plurality of wiring members 90 are electrically joined to each other. A plurality of recessed portions 35 which are arranged in the vertical direction Z are formed in the attachment surface 33a. The plurality of recessed portions 35 at least partially overlap the plurality of first terminal portions 63 when seen in the attachment direction X. Accordingly, as described above, it is possible to stably and easily join the first terminal portions 63 and the second terminal portions 92 using the joining material 93 while curbing thermal damage of the board 60. For example, in comparison with a case in which the plurality of first terminal portions 63 overlap one recessed portion 35 when seen in the attachment direction X, it is possible to decrease the area in which the recessed portion 35 is formed in the attachment surface 33a. Accordingly, it is possible to increase a contact area between the attachment surface 33a and the board 60 in a region other than a region overlapping the first terminal portions 63 in the attachment direction X. As a result, in a place other than a place in which the joining material 93 needs to be melted, it is possible to easily dissipate heat applied to the board 60 to the main body 30a. Accordingly, it is possible to further curb thermal damage of the board 60.

Embodiments different from the aforementioned embodiment will be described below. In the following description of the embodiments, description of the same configuration as the configuration described above the description of the embodiments may be omitted by appropriately referring to the configuration using the same reference signs. Differences of parts corresponding to the constituents of the same configuration as the configuration described above the description of the embodiments from the aforementioned configuration may be described by appropriately referring to the parts using the same names and different reference signs, and description of the same configuration as described above may be omitted. As the constituents of which description is omitted in the following embodiments, the same configuration as the configuration described above the description of the embodiments can be employed.

### Second embodiment

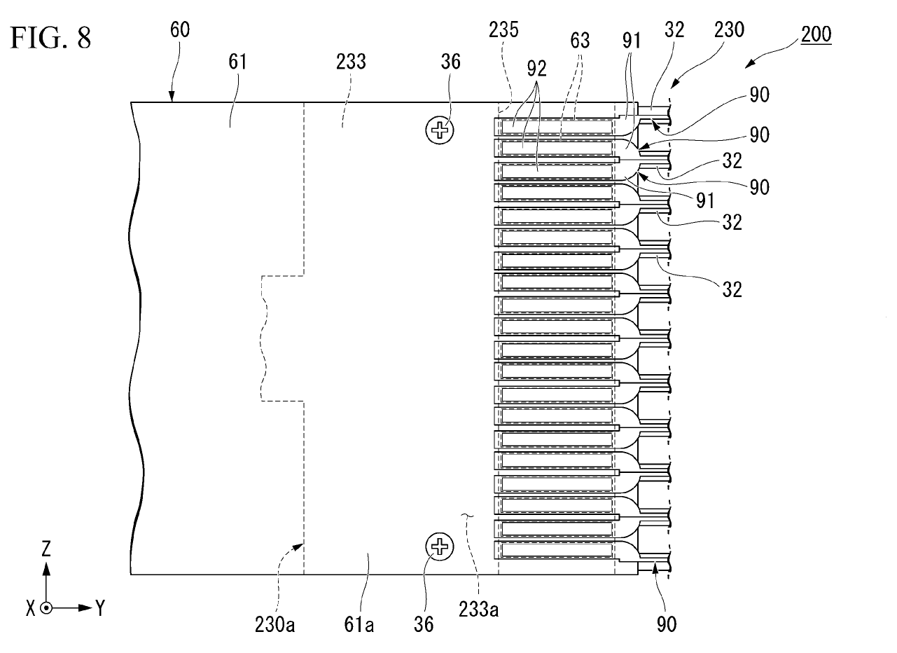

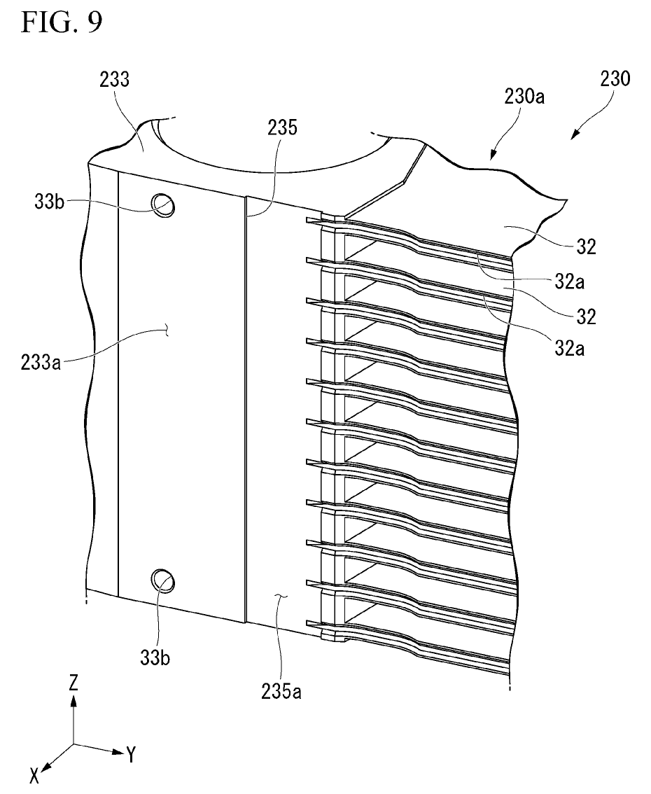

FIG. 8 is a diagram illustrating a part of a disk drive 200 according to a second embodiment. FIG. 9 is a perspective view illustrating a part of a main body 230a of a head assembly 230 according to the second embodiment. As illustrated in FIGS. 8 and 9, only one recessed portion 235 is formed in an attachment surface 233a of a base 233 in the second embodiment. The one recessed portion 235 extends in the vertical direction Z. The recessed portion 235 is formed from an upper edge of the attachment surface 233a to a lower edge thereof in the vertical direction Z. In other words, the recessed portion 235 in the second embodiment is formed all over the attachment surface 233a in the vertical direction Z. An end on the extension-direction one side (the +Y side) of the recessed portion 235 is further separated to the extension-direction other side (the –Y side) with respect to the extension-direction one side of the base 233. As illustrated in FIG. 9, ends on the extension-direction other side of a plurality of grooves 32a are formed on a bottom surface 235a of the recessed portion 235.

As illustrated in FIG. 8, the recessed portion 235 in the second embodiment overlaps at least a part of each of two or more first terminal portions 63 when seen in the attachment direction X. More specifically, the recessed portion 235 overlaps all of a plurality of first terminal portions 63 when seen in the attachment direction X. The recessed portion 235 in the second embodiment overlaps all of a plurality of second terminal portions 92 when seen in the attachment direction X.

The other configuration of the main body 230a is the same as the other configuration of the main body 30a in the first embodiment. The other configuration of the head assembly 230 is the same as the other configuration of the head assembly 30 in the first embodiment. The other configuration of the disk drive 200 is the same as the other configuration of the disk drive 100 in the first embodiment.

According to the second embodiment, the recessed portion 235 overlaps at least a part of each of the two or more first terminal portions 63 when seen in the attachment direction X (the first direction). Accordingly, in comparison with a case in which the recessed portion 235 is formed for each of the plurality of first terminal portions 63, it is possible to more easily decrease the number of recessed portions 235. As a result, it is possible to decrease the number of process steps which are required for an operation of forming the recessed portion 235.

According to the second embodiment, the recessed portion 235 overlaps all of the plurality of first terminal portions 63 when seen in the attachment direction X (the first direction). Accordingly, when the first terminal portions 63 and the corresponding second terminal portions 92 are jointed to each other using a joining material 93, it is possible to further curb dissipation of heat from the joining material 93 to the main body 230a. As a result, it is possible to further curb thermal damage of the board 60. By forming only one recessed portion 235 in the main body 230a, it is possible to curb thermal damage of the board 60 while stably joining the plurality of first terminal portions 63 and the plurality of second terminal portions 92. Accordingly, it is possible to decrease the number of process steps which are required for an operation of forming the recessed portion 235.

According to the second embodiment, the recessed portion 235 is formed from an edge on the top side (one side) of the attachment surface 233a to an edge on the bottom side (the other side) in the vertical direction Z (the second direction). Accordingly, for example, when the recessed portion 235 is formed by machining, it is possible to more easily form the recessed portion 235 by performing machining on a part of the attachment surface 233a as a whole in the vertical direction Z in comparison with a case in which machining is performed on only a part of the attachment surface 233a partially in the vertical direction Z. The machining which is performed on a part of the attachment surface 233a to form the recessed portion 235 is, for example, cutting or press working. For example, when the recessed portion 235 is formed by metallic molding, it is possible to more easily curb complication in shape of a mold by forming the recessed portion 235 in the whole attachment surface 233a in the vertical direction Z in comparison with a case in which the recessed portion 235 is formed in only a part in the vertical direction Z of the attachment surface 233a.

### Third embodiment

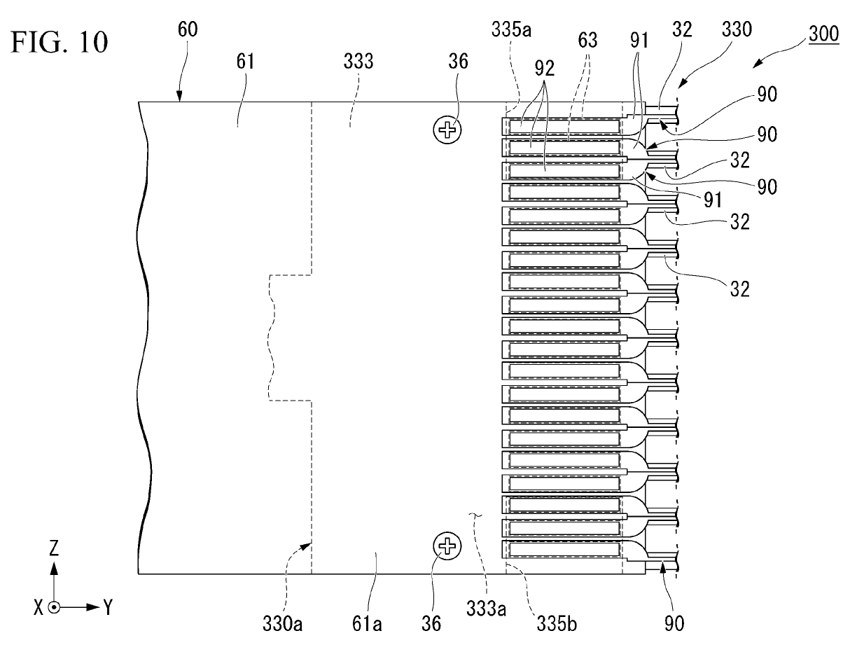

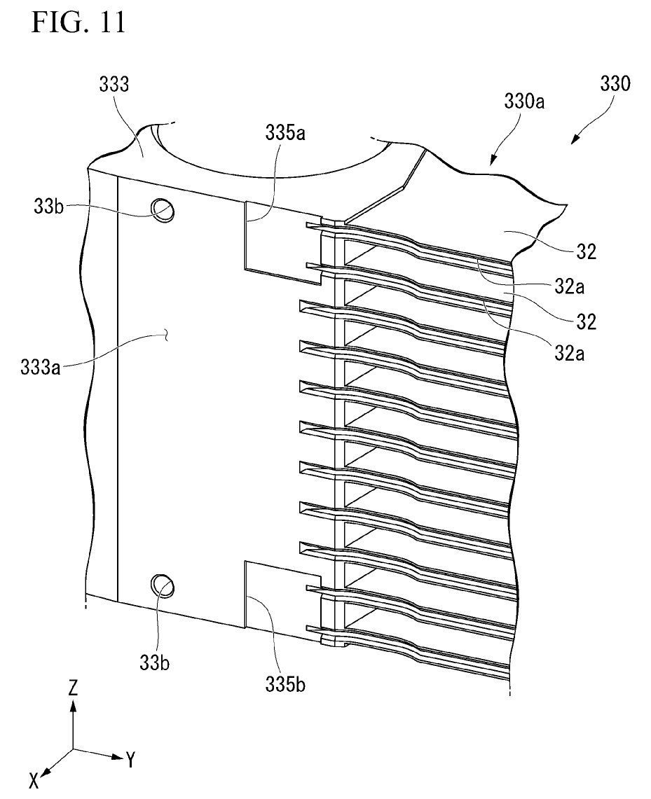

FIG. 10 is a diagram illustrating a part of a disk drive 300 according to a third embodiment. FIG. 11 is a perspective view illustrating a part of a main body 330a of a head assembly 330 according to the third embodiment. As illustrated in FIGS. 10 and 11, two recessed portions 335a and 335b which are separated in the vertical direction Z are formed in an attachment surface 333a of a base 333 in the third embodiment. One recessed portion 335a of the two recessed portions 335a and 335b is formed at an upper end of the attachment surface 333a. An upper edge of the recessed portion 335a is formed at an upper edge of the attachment surface 333a. The inside of the recessed portion 335a is open upward. An end on the extension-direction one side (the +Y side) of the recessed portion 335a is further separated to the extension-direction other side (the –Y side) with respect to an end on the extension-direction one side of a base 333. The other recessed portion 335b of the two recessed portions 335a and 335b is formed at a lower end of the attachment surface 333a. A lower edge of the recessed portion 335b is formed at a lower edge of the attachment surface 333a. The inside of the recessed portion 335b is open downward. An end on the extension-direction one side of the recessed portion 335b is further separated to the extension-direction other side with respect to an end on the extension-direction one side of the base 333. In the third embodiment, the recessed portions 335a and 335b have a rectangular shape when seen in the attachment direction X.

As illustrated in FIG. 10, the recessed portion 335a overlaps three first terminal portions 63 including one first terminal portion 63 located on the uppermost side and two first terminal portions 63 arranged downward from the one first terminal portion 63 out of a plurality of first terminal portions 63 when seen in the attachment direction X. The recessed portion 335b overlaps three first terminal portions 63 including one first terminal portion 63 located on the lowermost side and two first terminal portions 63 arranged upward from the one first terminal portion 63 out of the plurality of first terminal portions 63 when seen in the attachment direction X. The first terminal portions 63 other than six first terminal portions 63 overlapping the recessed portions 335a and 335b when seen in the attachment direction X do not overlap the recessed portions 335a and 335b when seen in the attachment direction X. That is, in the third embodiment, only some first terminal portions 63 out of the plurality of first terminal portions 63 overlap the recessed portions 335a and 335b when seen in the attachment direction X, and the other first terminal portions 63 do not overlap the recessed portions 335a and 335b when seen in the attachment direction X.

The other configuration of the main body 330a is the same as the other configuration of the main body 230a in the second embodiment. The other configuration of the head assembly 330 is the same as the other configuration of the head assembly 230 in the second embodiment. The other configuration of the disk drive 300 is the same as the other configuration of the disk drive 200 in the second embodiment.

According to the third embodiment, two recessed portions 335a and 335b which are separated in the vertical direction Z (the second direction) are formed in the attachment surface 333a. One (the recessed portion 335a) of the two recessed portions 335a and 335b is formed at an end on the top side (one side) in the vertical direction Z of the attachment surface 333a. The other (the recessed portion 335b) of the two recessed portions 335a and 335b is formed at an end on the bottom side (the other side) in the vertical direction Z of the attachment surface 333a. Accordingly, it is possible to make it difficult to dissipate heat applied to the joining material 93 for joining the first terminal portions 63 to the main body 330a at both ends in the vertical direction Z at which the intensity of laser light L to be applied is likely to decrease in the board 60. As a result, it is possible to easily join the first terminal portions 63 disposed at both ends in the vertical direction Z to the second terminal portions 92 using the joining material 93 while curbing thermal damage of the board 60 by decreasing the intensity of the laser light L. It is possible to bring the attachment surface 333a into contact with the board 60 between the two recessed portions 335a and 335b in the vertical direction Z. Accordingly, it is possible to make it easy to dissipate heat of the board 60 to the main body 330a in a central part in the vertical direction Z in which the intensity of the laser light L to be applied is likely to increase in the board 60. As a result, it is possible to curb thermal damage of the central part in the vertical direction Z of the board 60. Since the intensity of the laser light L in the central part in the vertical direction Z is higher, it is possible to curb non-melting of the joining material 93 even when heat of the board 60 is dissipated to the main body 330a. Accordingly, it is possible to curb non-joining of the first terminal portions 63 to the second terminal portions 92 in the central part in the vertical direction Z of the board 60.

### Fourth embodiment

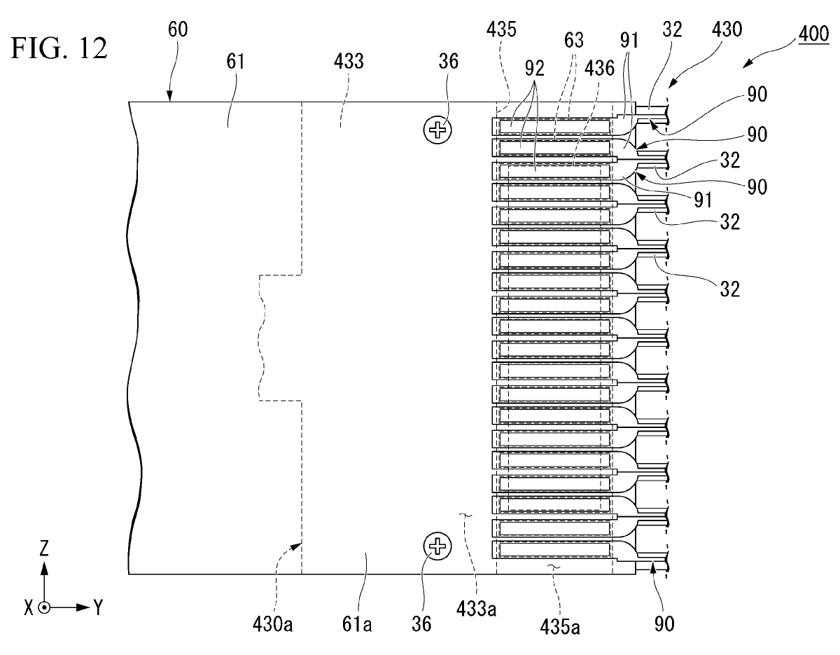

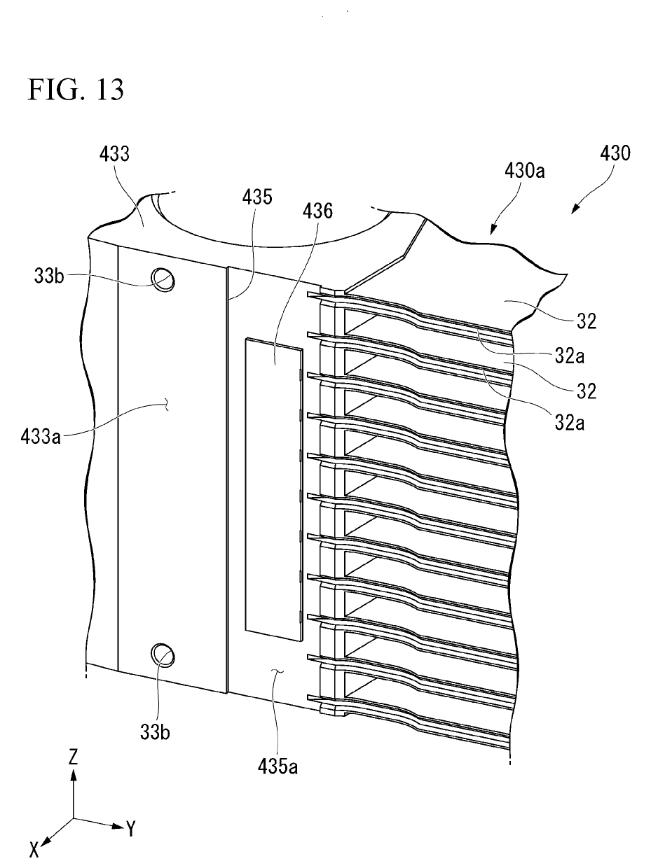

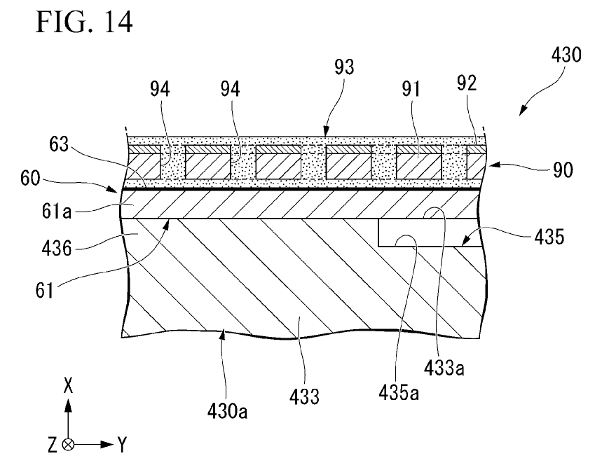

FIG. 12 is a diagram illustrating a part of a disk drive 400 according to a fourth embodiment. FIG. 13 is a perspective view illustrating a part of a main body 430a of a head assembly 430 according to the fourth embodiment. FIG. 14 is a sectional view of a part of the head assembly 430 according to the fourth embodiment. As illustrated in FIGS. 12 and 13, only one recessed portion 435 is formed in an attachment surface 433a of a base 433 in the fourth embodiment. When seen in the attachment direction X, the appearance of the recessed portion 435 is the same as the appearance of the recessed portion 235 in the second embodiment. As illustrated in FIG. 14, the recessed portion 435 includes a bottom surface 435a. The bottom surface 435a faces the board 60 in the attachment direction X. The bottom surface 435a is separated to the second side from a surface on the second side (the –X side) of the board 60. The bottom surface 435a is located on the second side with respect to the attachment surface 433a.

A protruding portion 436 protruding toward the board 60 in the attachment direction X is formed on the bottom surface 435a. The protruding portion 436 protrudes from the bottom surface 435a to the first side (the +X side). The protruding portion 436 is in contact with the board 60. More specifically, the surface on the first side of the protruding portion 436 is in contact with a surface on the second side (the –X side) of an attached portion 61a of the board 60. The surface on the first side of the protruding portion 436 is a plane perpendicular to the attachment direction X. The surface on the first side of the protruding portion 436 is disposed at the same position as the attachment surface 433a in the attachment direction X.

As illustrated in FIG. 13, the protruding portion 436 is separated in the vertical direction Z from both edges in the vertical direction Z of the bottom surface 435a. A top end of the protruding portion 436 is located below an upper edge of the bottom surface 435a. A bottom end of the protruding portion 436 is located above a lower edge of the bottom surface 435a. The protruding portion 436 is separated in the extension direction Y from both edges in the extension direction Y of the bottom surface 435a. An end on the extension-direction one side (the +Y side) of the protruding portion 436 is located on the extension-direction other side (the –Y side) with respect to the edge on the extension-direction one side of the bottom surface 435a. An end on the extension-direction other side of the protruding portion 436 is located on the extension-direction one side with respect to the edge on the extension-direction other side of the bottom surface 435a. In the fourth embodiment, the protruding portion 436 has a rectangular shape which is long in the vertical direction Z when seen in the attachment direction X. Since the protruding portion 436 is formed, the recessed portion 435 is formed in an annular shape surrounding the protruding portion 436 when seen in the attachment direction X. More specifically, the recessed portion 435 is a rectangular frame shape surrounding the protruding portion 436 when seen in the attachment direction X.

As illustrated in FIG. 12, the protruding portion 436 overlaps at least a part of some first terminal portions 63 of the plurality of first terminal portions 63 when seen in the attachment direction X. The protruding portion 436 overlaps at least a part of at least one first terminal portion 63 which is located below the uppermost first terminal portion 63 and located above the lowermost first terminal portion 63 when seen in the attachment direction X. More specifically, the protruding portion 436 overlaps at least a part of the first terminal portions 63 other than a total of four first terminal portions 63 including two first terminal portions 63 from the uppermost first terminal portion 63 and two first terminal portions 63 from the lowermost first terminal portion 63 when seen in the attachment direction X. The protruding portion 436 overlaps a part other than both ends in the extension direction Y of each first terminal portion 63 when seen in the attachment direction X.

The protruding portion 436 overlaps at least a part of some second terminal portions 92 of the plurality of second terminal portions 92 when seen in the attachment direction X. The protruding portion 436 overlaps at least a part of at least one second terminal portion 92 which is located below the uppermost second terminal portion 92 and located above the lowermost second terminal portion 92 when seen in the attachment direction X. More specifically, the protruding portion 436 overlaps at least a part of the second terminal portions 92 other than a total of four second terminal portions 92 including two second terminal portions 92 from the uppermost second terminal portion 92 and two second terminal portions 92 from the lowermost second terminal portion 92 when seen in the attachment direction X. The protruding portion 436 overlaps a part other than both ends in the extension direction Y of each second terminal portion 92 when seen in the attachment direction X.

The other configuration of the main body 430a is the same as the other configuration of the main body 230a in the second embodiment. The other configuration of the head assembly 430 is the same as the other configuration of the head assembly 230 in the second embodiment. The other configuration of the disk drive 400 is the same as the other configuration of the disk drive 200 in the second embodiment.

According to the fourth embodiment, the protruding portion 436 protruding in the attachment direction X (the first direction) to the board 60 is formed on the bottom surface 435a of the recessed portion 435. The protruding portion 436 is separated in the vertical direction Z from both edges in the vertical direction Z (the second direction) of the bottom surface 435a and is in contact with the board 60. Accordingly, it is possible to make it easy to dissipate heat of the board 60 to the main body 430a via the protruding portion 436 in the central part in the vertical direction Z in which the intensity of laser light L to be applied is likely to increase in the board 60. As a result, when the first terminal portions 63 and the second terminal portions 92 are joined, it is possible to curb thermal damage of the central part in the vertical direction Z of the board 60.

The head assembly according to at least one of the aforementioned embodiments is a head assembly that is provided in a disk drive. The head assembly according to the embodiment includes a head, a main body to which the head is attached, a wiring member that is electrically connected to the head, and a board that is attached to the main body. The board includes a first terminal portion. The wiring member includes a second terminal portion that is electrically joined to the first terminal portion. The main body includes an attachment surface to which the board is attached. At least a part of the first terminal portion and at least a part of the second terminal portion overlap each other when seen in a first direction perpendicular to the attachment surface. A recessed portion that is recessed in a direction away from the board is formed in the attachment surface. The recessed portion overlaps at least a part of the first terminal portion when seen in the first direction. Accordingly, it is possible to curb dissipation of heat applied to a joining material for joining the first terminal portion to the main body using the recessed portion. As a result, it is possible to easily decrease an amount of heat applied to melt the joining material when joining the wiring member and the board and to curb thermal damage of the board when joining the wiring member and the board.

The number of recessed portions which are formed in the attachment surface is not particularly limited as long it is equal to or greater than 1. The shape of the recessed portion is not particularly limited. The recessed portion may be a hole penetrating the base. The number of first terminal portions, the number of wiring members, and the number of heads are not particularly limited as long as they are equal to or greater than 1. In the aforementioned embodiments, a configuration in which the first terminal portions and the second terminal portions are joined using the joining material has been exemplified, but the embodiments are not limited thereto. The method of electrically connecting the first terminal portions and the second terminal portions is not particularly limited as long as it is a method of applying heat. The first terminal portions and the second terminal portions may be electrically connected to each other without using the joining material. In this case, for example, the first terminal portions and the second terminal portions may be electrically connected to each other by diffused junction or may be electrically connected to each other by welding. In this case, it is possible to make it difficult to dissipate heat applied to the constituents to the main body using the recessed portion when the first terminal portions and the second terminal portions are joined. Accordingly, it is possible to make it easy to decrease an amount of heat applied to the first terminal portions and the second terminal portions to join the first terminal portions and the second terminal portions and to curb thermal damage of the board when the wiring members and the board are joined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A head assembly that is provided in a disk drive, the head assembly comprising:
a head;
a main body to which the head is attached;
a wiring member that is electrically connected to the head; and
a board that is attached to the main body,
wherein the board includes a first terminal portion,
wherein the wiring member includes a second terminal portion that is electrically joined to the first terminal portion,
wherein the main body includes an attachment surface to which the board is attached,
wherein at least a part of the first terminal portion and at least a part of the second terminal portion overlap each other when seen in a first direction perpendicular to the attachment surface,
wherein a recessed portion that is recessed in a direction away from the board is formed in the attachment surface, and
wherein the recessed portion overlaps at least a part of the first terminal portion when seen in the first direction.

2. The head assembly according to claim 1, further comprising:
a plurality of heads including the head; and
a plurality of wiring members including the wiring member,
wherein the board includes a plurality of first terminal portions including the first terminal portion,
wherein the plurality of first terminal portions are arranged in a second direction perpendicular to the first direction,
wherein the plurality of first terminal portions and the second terminal portions of the plurality of wiring members are electrically joined to each other,
wherein a plurality of recessed portions including the recessed portion are formed in the attachment surface,
wherein the plurality of recessed portions are arranged in the second direction, and
wherein the plurality of recessed portions at least partially overlap the plurality of first terminal portions when seen in the first direction.

3. The head assembly according to claim 1, further comprising:
a plurality of heads including the head; and
a plurality of wiring members including the wiring member,
wherein the board includes a plurality of first terminal portions including the first terminal portion,
wherein the plurality of first terminal portions are arranged in a second direction perpendicular to the first direction,
wherein the plurality of first terminal portions and the second terminal portions of the plurality of wiring members are electrically joined to each other, and
wherein the recessed portion at least partially overlaps each of two or more first terminal portions when seen in the first direction.

4. The head assembly according to claim 3, wherein the recessed portion overlaps all of the plurality of first terminal portions when seen in the first direction.

5. The head assembly according to claim 1, further comprising:
a plurality of heads including the head; and
a plurality of wiring members including the wiring member,
wherein the board includes a plurality of first terminal portions including the first terminal portion,
wherein the plurality of first terminal portions are arranged in a second direction perpendicular to the first direction,
wherein the plurality of first terminal portions and the second terminal portions of the plurality of wiring members are electrically joined to each other,
wherein the recessed portion includes a bottom surface facing the board in the first direction,
wherein a protruding portion protruding in the first direction to the board is formed on the bottom surface, and
wherein the protruding portion is separated in the second direction from both edges in the second direction of the bottom surface and is in contact with the board.

6. The head assembly according to claim 1, wherein the recessed portion is formed from an edge on one side of the attachment surface to an edge on the other side of the attachment surface in a second direction perpendicular to the first direction.

7. The head assembly according to claim 1, further comprising:
a plurality of heads including the head; and
a plurality of wiring members including the wiring member,
wherein the board includes a plurality of first terminal portions including the first terminal portion,
wherein the plurality of first terminal portions are arranged in a second direction perpendicular to the first direction,
wherein the plurality of first terminal portions and the second terminal portions of the plurality of wiring members are electrically joined to each other,
wherein two recessed portions including the recessed portion are formed in the attachment surface,
wherein the two recessed portions are separated in the second direction,
wherein one of the two recessed portions is formed at an end on one side in the second direction of the attachment surface, and
wherein the other of the two recessed portions is formed at an end on the other side in the second direction of the attachment surface.

8. A disk drive comprising:
a head assembly; and
a disk,
wherein the head assembly includes
a head,
a main body to which the head is attached,
a wiring member that is electrically connected to the head, and
a board that is attached to the main body,
wherein the board includes a first terminal portion,
wherein the wiring member includes a second terminal portion that is electrically joined to the first terminal portion,
wherein the main body includes an attachment surface to which the board is attached,
wherein at least a part of the first terminal portion and at least a part of the second terminal portion overlap each other when seen in a first direction perpendicular to the attachment surface,
wherein a recessed portion that is recessed in a direction away from the board is formed in the attachment surface, and
wherein the recessed portion overlaps at least a part of the first terminal portion when seen in the first direction.
